(19) United States
(12) Patent Application Publication
(10) Pub. No.: US 2025/0225586 A1
(43) Pub. Date: Jul. 10, 2025

(54) Method and System for Options Flow Analysis Using a Comprehensive Configurable Interactive Multidimensional Tabular View

(71) Applicant: Ryan Scott Wilson, Richmond, VA (US)

(72) Inventor: Ryan Scott Wilson, Richmond, VA (US)

(73) Assignee: Ryan Scott Wilson, Richmond, VA (US)

(21) Appl. No.: 19/006,209

(22) Filed: Dec. 30, 2024

(51) Int. Cl. G06Q 40/06; G06F 16/28; G06Q 40/04

(52) U.S. Cl. CPC G06Q 40/06; G06F 16/287; G06Q 40/04

(57) ABSTRACT

A method and system for reducing the time it takes traders to interpret options time and sales data, identify opportunities, and make better trading decisions. The invention automatically processes, enriches, interprets, and aggregates options flow and related data, delivering the refined data via a multidimensional user interface. The method includes receiving raw data with parameters such as strike price, expiration date, and volume, and enriching it with reference data and derived metrics, including underlying security attributes and trade volume aggregates. The data is stored in a multidimensional structure and rendered into a comprehensive and configurable interactive tabular view, enabling users to dynamically explore, analyze, sort, filter, group, and drill into specific trades. The system efficiently handles large data volumes, enabling efficient interpretation of noteworthy or complex trading activity such as multi-leg spread and roll trades, ultimately providing traders with a powerful tool for data analysis and decision-making.

### BACKGROUND OF THE INVENTION

### Field of the Invention

In general, the present invention relates to the field of public financial market information services; more specifically, it relates to methods and systems for processing, analyzing, and summarizing options time and sales data to improve trading decision-making.

### Historical Context

Public stock markets are vital to the function of modern capitalism, and options are as timeless and essential as common stocks themselves. When the world's first public joint-stock company and stock exchange were invented in 1602 in Amsterdam, derivatives trading followed almost immediately thereafter. By the early 1610s, the precursors to modern standardized futures and option contracts were robustly traded there, both for speculative purposes and also as a practical means of gaining exposure to the increasingly expensive Dutch East India Company shares. In the U.S., derivatives trading was similarly robust alongside the growth of its public financial markets, but futures and forwards were dominant, particularly for agricultural commodities. With the advent of the Black-Scholes formula in 1973, options trading was reignited. Soon followed the establishment of the Chicago Board Options Exchange (CBOE), the Options Clearing Corporation (OCC), and the Options Price Reporting Authority (OPRA). Today, options are so heavily traded and integral to public market function that the underlying notional quantity of shares that they control can well exceed the number of common shares traded in a day.

Unlike futures and forwards, whereby two parties agree to transact at a future date but unknown future price, options involve the selection of not only a time horizon but also a specific price, the strike price. This combination of features provides the speculator or hedger with a panoply of choice, a veritable checkerboard of expirations and strike prices to select from. Market participants naturally find their way to the intersections, the particular contracts, that best fit their needs. Options today are traded by everyone from the smallest retail traders to the largest institutions, so many thousands of trades or even a single very large trade on a particular contract can be highly revealing as to the market's specific expectations of how much an underlying security is likely to move or not move, in what direction, and over what timeframe. This information can be far more revealing than a simple tally of common shares bought or sold on the day. The increasing utilization of options also creates a positive feedback loop whereby the monitoring of recent noteworthy option trades can lead other traders to opportunities that they might not otherwise have noticed and who may themselves utilize options to implement their own trade. Naturally, the study and monitoring of options activity has become highly popular among market participants.

Further, options trading has matured to such an extent that many traders today routinely utilize multiple contracts in tandem to implement a specific position. Two-leg and three-leg spreads are frequently utilized to target a specific range with limited upside or downside but also limited required capital or risk. Four-or more leg spreads are frequently utilized to trade the implied volatility crush around binary events, such as earnings announcements. On top of that, all option position types, including multi-leg positions, are frequently rolled from their present expiry to a later one, a transaction in which the trader is essentially buying more time; the roll of a four-legged position results in at least eight distinct option transactions.

The result of these contemporary realities is that the consolidated OPRA data feed for a single day's options trades can easily exceed millions of rows and is ever expanding. It is already difficult enough to attain certainty as to whether a given option transaction was a purchase or sale by the customer and to open or to close, but now also there can be multiple legs involved-each on their own row in the raw dataset-to be connected and assessed together to infer the nature of the trade. Modern high-frequency electronic exchanges, of which there are 17 today in the U.S. options market and counting, also result in many trades being filled in multiple executions by sweeping exchanges in a blink or by filling an order in small bites over the course of a day or even several days. This description of the nature and scale of options time and sales data illustrates the problem of efficient interpretation and analysis of that data, which is of great interest to traders and which this invention helps to solve.

### Prior Art Description

The field of options flow analysis has seen a variety of approaches and tools aimed at assisting traders in identifying and interpreting what is now known as unusual options activity (UOA). Existing tools generally fall into one of two categories:

Individual Alert Systems: These systems provide real-time or near-real-time textual notifications for specific trades of interest, which may be configurable by the user to some extent but in some cases not at all. Typically, the offering includes curated insights or trade interpretations performed by expert service providers, such as the highlighting and explanation of particularly interesting or compelling trades as they hit the tape, or daily summaries delivered via email or blog. Although useful to a trader seeking real-time information, these systems lack comprehensive data exploration capabilities, requiring users to rely solely on the predefined alert criteria or on the curation and interpretation of the service provider.

Query-Based Analysis Platforms: Several platforms available today allow users to query options trading and related data and view the results in tabular formats. This is more useful to the trader who wants to better see a bigger picture that the individual textual alerts method cannot provide, and may be performing such research when the market is closed and real-time data is less important. While these tools provide some degree of flexibility for user-defined exploration, their designs remain limited to two-dimensional views of data. The scope of the defined queries is often highly limited, and any raw data downloads are also usually highly limited by volume and rarely user configurable. These aspects of conventional query-based analysis platforms restrict the efficient aggregation and interpretation of all data in a holistic sense, preventing the user from efficiently exploring the data in a comprehensive manner with ease. Despite the development of these platforms, most traders today still revert to the practice of manually reading the time and sales data and interpreting it themselves, one row at a time. Synthesis of information and insight discovery is constrained wherever all relevant data is not placed at the fingertips of the user within a single interactive and configurable view, such as where reference data is not included in each table and can only be obtained by separately querying additional tables.

Further, existing methods fail to address several critical challenges in options flow analysis, including:

Open Interest Analysis: Unlike stocks, derivatives are a contract market; the quantity outstanding grows and shrinks based on how many contracts have been traded and are still in effect or “open” as of a specific point in time. U.S. options open interest data is published each trading day by the OCC at 6:30 AM EST, and is effectively as of the close of the prior trading day because listed options are generally only tradeable during regular market hours, 9:30 AM to 4:00 PM EST. Existing tools only provide the latest available open interest data as of the time of a given trade, which would be as of the end of the prior trading day. Existing tools provide no display of both pre-trade and post-trade open interest data in tandem and within a single view. For accurate interpretation, an option trade quantity must be compared against the contract's open interest both before and after the trade to fully assess whether the trade was opening at the time of the trade and also still outstanding by the end of the trading day, i.e., after any subsequent sale, expiration, option exercises, cancellation, etc. Although some practitioners understand this nuance, many market participants do not. Among those that do know, this action of checking the open interest the next morning is still performed manually today and is thus burdensome and only performed for trades of particular interest where the user holds in personal memory or must make manual note to remember to check the contract open interest the next morning. No platforms or services today place the open interest data both before and after the trade at the fingertips of the user and within a single view. Although the claimed invention in its totality is broader in scope than this one aspect, this improvement naturally rises to the level of an independent claim.

Trade Directionality and Aggregation: Another key aspect of option trade interpretation is directionality of the trade. The question is: did the customer most likely buy or sell the contract from the market maker? Comparison of trade price to the quoted bid and ask prices at the time of the trade is the dominant method today, but other methods exist and can be combined, such as evaluating the quoted bid and offered quantities at the time of the trade, changes in implied volatility on the contract or underlying stock, price action in the underlying stock, identification of related stock trades such as the market maker's delta hedging, and others. These methods other than trade price are worth considering because trade price-based interpretation is imperfect. For instance, larger option trades can be pre-negotiated by phone and subsequently entered into reporting systems with some time lag. One leg of a multi-leg trade can be filled several seconds or even minutes after the first leg, including stock-contingent option trades. Current alert systems and query-based platforms often provide either individual trade directional interpretations or aggregated directional interpretations, but not both simultaneously in a single, cross-sectional display. This limits users' ability to easily derive a holistic view of the options flow. It is crucial to be able to see both at once because one large order, such as to buy 10,000 calls, may be filled over many smaller individual trades. Individual assessment of each trade in isolation might result in the conclusion that 7,500 of the calls were bought and 2,500 of the calls were sold, but if the trades are clearly related such as by timestamp or execution details, many practitioners would interpret this as a buy of 10,000 contracts. The simultaneous display of both individual and aggregated interpretations in a single view is vital to the efficient analytical consumption of options activity data.

Visual Integration: Few, if any, tools automatically overlay options activity directly onto underlying stock price charts, depriving users of the ability to efficiently visually correlate options trades with underlying stock price movements or key price levels. A trader naturally compares the options flow data to the underlying stock price chart, to see how the selected strike prices and expirations may align with apparent key levels on the stock price chart. This is performed manually by the user today, using separate charting tools that allow the user to create and save chart annotations, or simply mentally, consuming the trader's memory.

Delivery Method Constraints: Many contemporary options information tools are confined to specific delivery methods, such as web-based platforms or email notifications, making them less adaptable to varied user preferences and workflows. Some methods are also simply not presently compatible with the method and system described herein of placing all relevant data at the fingertips of the user in a single view to enable comprehensive analysis.

Despite advancements in data availability and computational power, these limitations have persisted in the area, leaving options traders reliant on time-consuming manual methods or narrowly focused tools. The present invention addresses these shortcomings by introducing a novel method and system that enables a comprehensive, multidimensional analysis of options flow data via a configurable and interactive tabular view, significantly improving the efficiency and accuracy of UOA interpretation and subsequent trading decisions.

### SUMMARY OF THE INVENTION

The present invention addresses the limitations of existing options flow analysis tools by introducing a method and system for a comprehensive and user-configurable, multidimensional, interactive approach to interpreting unusual options activity (UOA). The invention integrates key features that enable traders to efficiently analyze options trade data, resulting in actionable insights and perspective that was previously inaccessible or impractically achievable.

A central aspect of the invention is the application of business intelligence insights, systems, and methods to the contemporary problem of efficient options flow interpretation and analysis. A key insight that many traders may not grasp, since few of them may also be business intelligence experts, is that significant value flows from empowering the user by placing as much relevant data as possible at their fingertips and within a single view with snappy responsiveness. The user must be able to explore and configure the view themselves with ease and speed in order to move seamlessly between assessing the bigger picture, drilling down into an area of interest, and back up and out again. There is only so much space on a screen, so the user must also be free to include and exclude columns and rows of interest as their exploration and analysis evolves. The user must have the automatically interpreted options trade data and other relevant data all delivered to them in one stream via a comprehensive, configurable and interactive view; multidimensional data systems make this possible, and the tabular or matrix view specifically is far more useful than other visuals such as bar or pie charts in the options analysis context because the grid view is intuitive for spotting multi-leg trades and rolls and chunky activity on certain contracts. In a nutshell, the invention contemplates the end-to-end generation and delivery of a final work product that delivers this functionality to the end user.

Also central to the invention is the inclusion of dual open interest columns, displaying open interest data both as of the time of the trade and the next available following the trade. As mentioned above, this is a vital step in the accurate interpretation of options activity, even though no practitioner has demonstrated the application of both pre-and post-trade open interest in a single view. This innovative feature allows users to skip the present manual step of both remembering to check and then actually performing this check of the next day's open interest.

As also mentioned above, the interpretation of trade directionality is vital and nuanced. The invention further introduces a simultaneous, cross-sectional display of both the sum of individual trade directional interpretations and aggregated directional interpretations. For example, a single long call and single short put each traded on the same underlying security with matching expiration date and trade timestamp can be interpreted as a single synthetic long stock position. Two call trades on the same underlying security, one long and one short, each with the same expiration date and two different strike prices, can be interpreted as a vertical spread trade. By presenting this intersection within a single view, the system facilitates a holistic understanding of the options flow. The user can quickly see and grasp for instance that there may have been a variety of directional interpretations on a contract but that the majority of the activity was one interpretation in particular, such as Bought Call or Sold Put, and quickly move on to the next step of their analysis.

Additionally, the invention includes an automated visual overlay of options activity directly onto stock price charts, including key strike prices rendered as horizontal lines. This integration enables users to intuitively correlate options activity with the underlying stock's price movements, streamlining analysis and improving decision-making.

The system is also designed to be delivery method agnostic, supporting a variety of distribution mechanisms such as web interfaces, email reports, FTP transfers, and mobile applications. This ensures flexibility in meeting diverse user preferences and workflows.

By addressing these core deficiencies in current tools, the present invention represents a significant advancement in the field of options flow analysis, offering unprecedented utility, efficiency, and adaptability to all users and also to persons of ordinary skill in this art.

### BRIEF DESCRIPTION OF THE EXHIBITS

For a better understanding of the present invention, reference is made to the following description of an exemplary embodiment thereof, considered in conjunction with the accompanying exhibits, in which several user configurations of the view are presented to demonstrate the invention's function and utility:

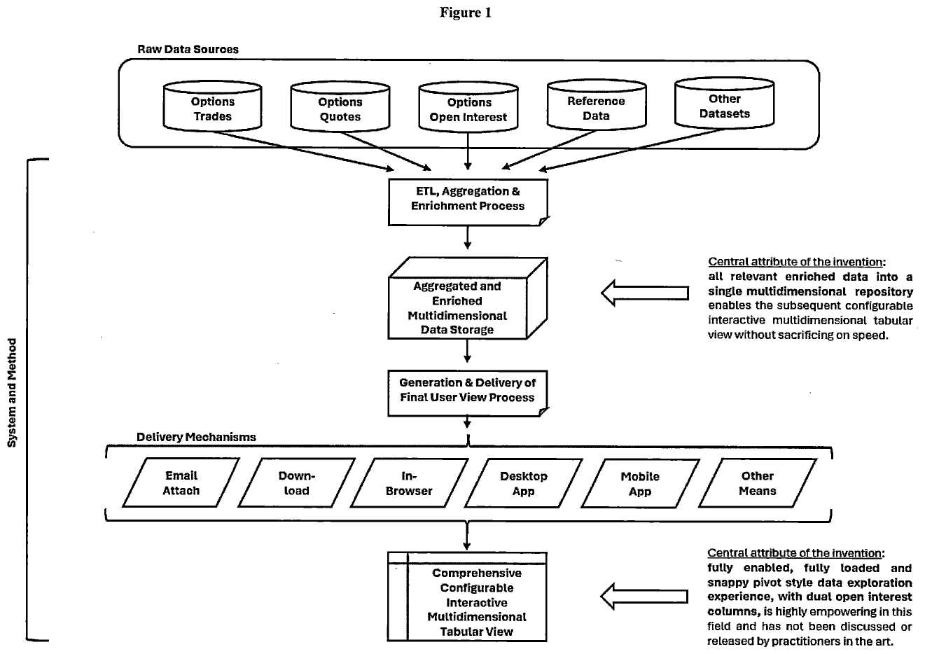

FIG. 1 illustrates the data flow and processing steps that culminate in the final viewer tool that delivers the new utility to the user;

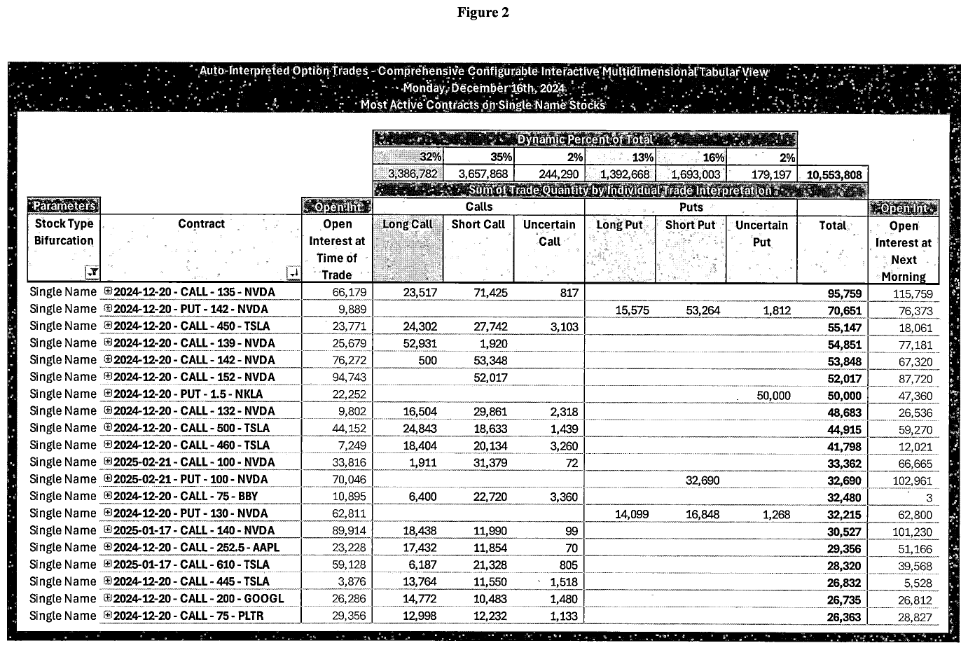

FIG. 2 illustrates the viewer tool filtered on single name stocks and sorted by total trade quantity in descending order, resulting in a view of the most actively traded contracts on single name stocks for the Dec. 16, 2024 trading day;

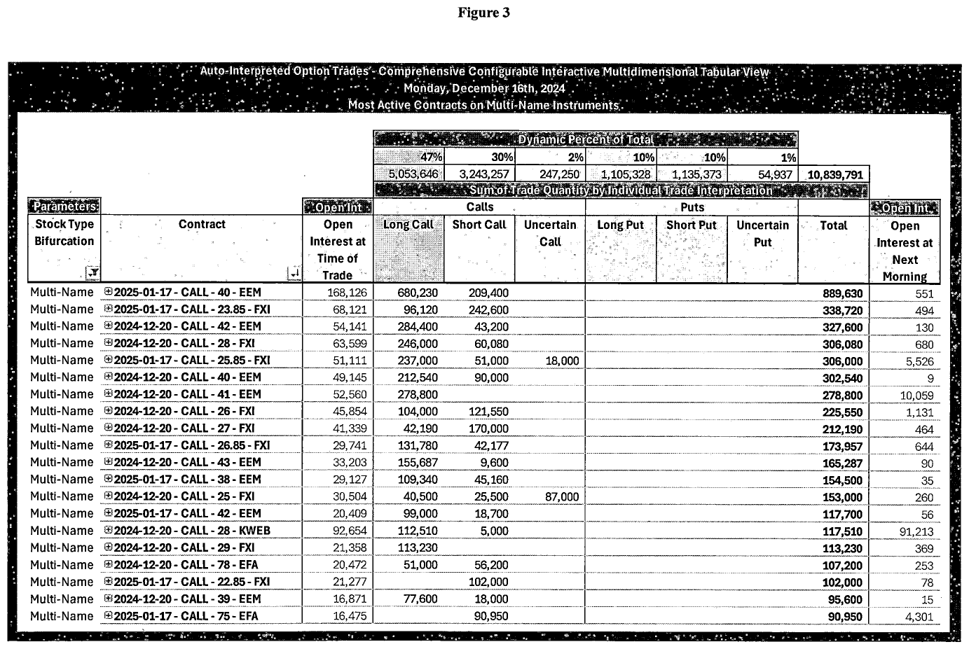

FIG. 3 illustrates the viewer tool filtered on multi-name instruments (e.g. exchange-traded funds, closed-end funds, etc.) and sorted by total trade quantity in descending order, resulting in a view of the most actively traded contracts on multi-name instruments for the Dec. 16, 2024 trading day;

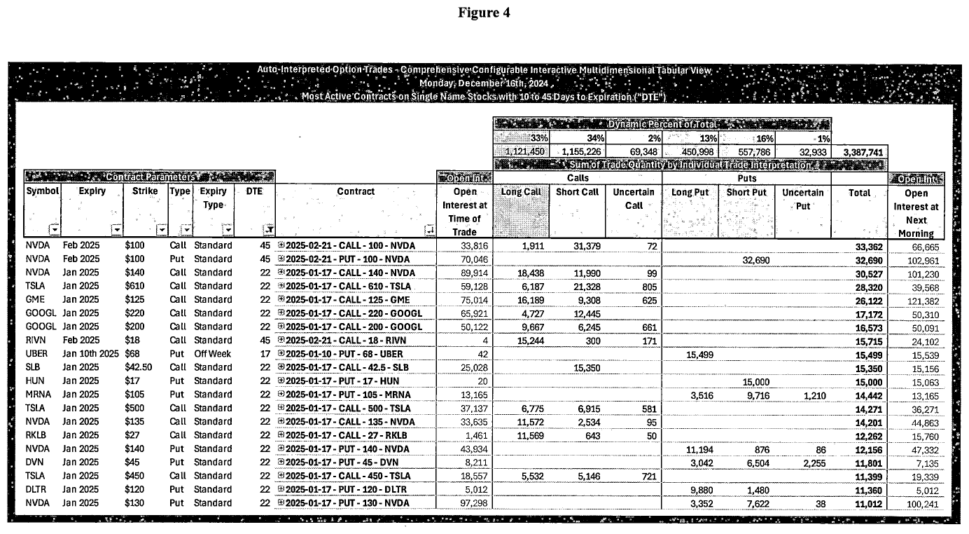

FIG. 4 illustrates the viewer tool filtered on single name stocks and option contracts having between 10and 45 days to expiration (“DTE”), and sorted by total trade quantity in descending order, resulting in a view of the most actively traded contracts on single name stocks within this expiration range of interest which a user might select, for the Dec. 16, 2024 trading day;

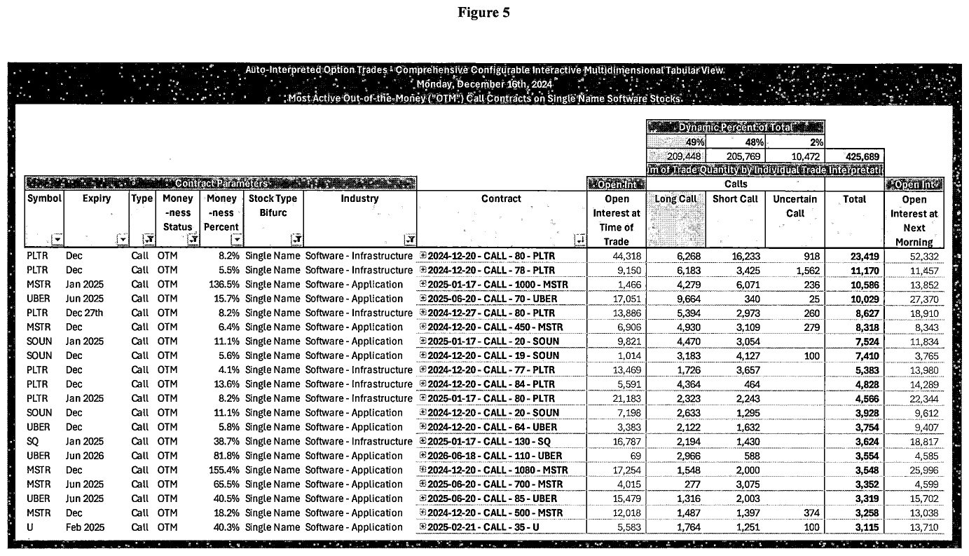

FIG. 5 illustrates the viewer tool filtered on out-of-the-money (“OTM”) call contracts on single name stocks of companies in the software industry, and sorted by total trade quantity in descending order, resulting in a view of the most actively traded contracts on single name stocks meeting these criteria of interest which a user might select, for the Dec. 16, 2024 trading day;

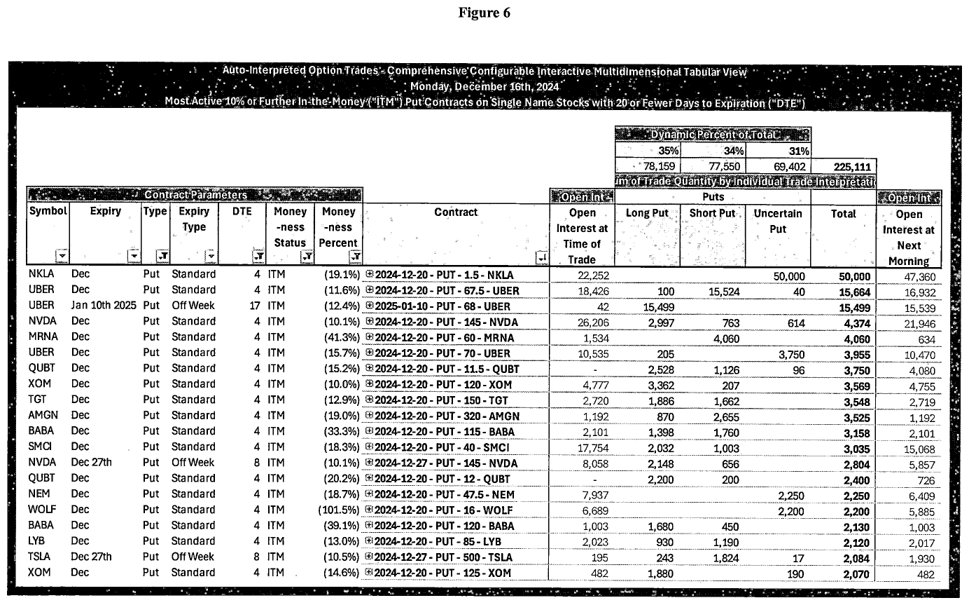

FIG. 6 illustrates the viewer tool filtered on in-the-money (“ITM”) put contracts on single name stocks having 20 or fewer DTE and sorted by total trade quantity in descending order, resulting in a view of the most actively traded contracts on single name stocks meeting these criteria of interest which a user might select, for the Dec. 16, 2024 trading day;

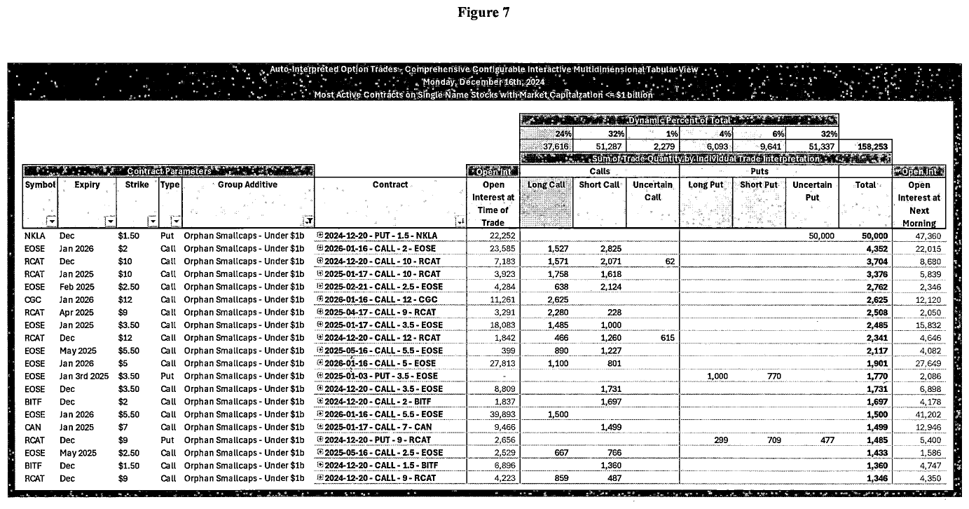

FIG. 7 illustrates the viewer tool filtered on “small cap” single name stocks i.e. those having a market capitalization of $1 billion or less, and sorted by total trade quantity in descending order, resulting in a view of the most actively traded contracts on single name stocks meeting these criteria of interest which a user might select, for the Dec. 16, 2024 trading day;

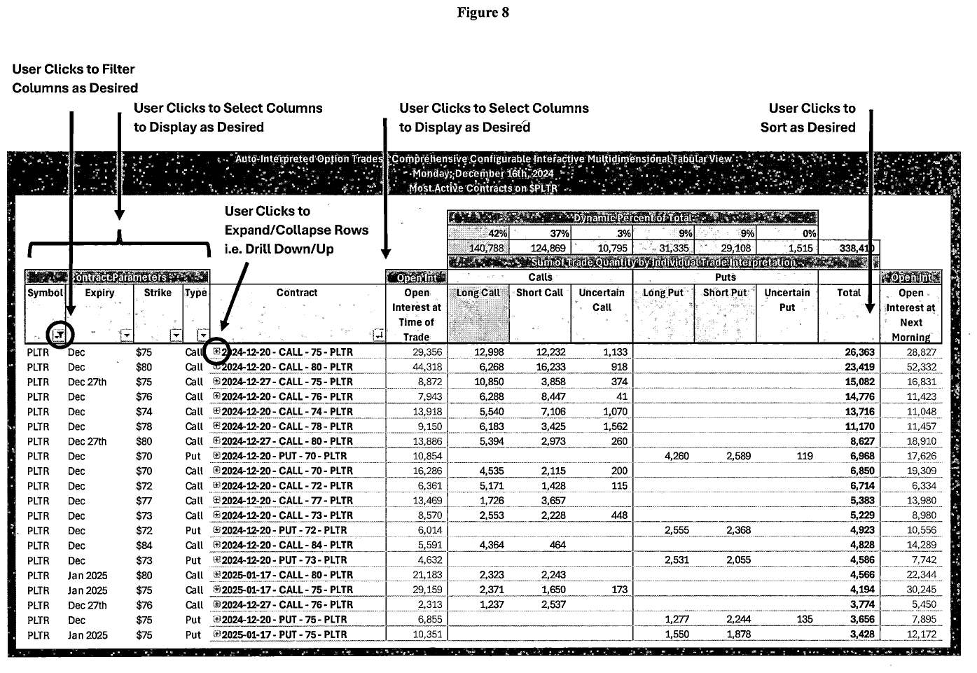

FIG. 8 includes specific red arrow and circle user annotations and illustrates the tool filtered on a single underlying stock of interest, in this case $PLTR, and sorted by total trade quantity in descending order, resulting in a view of the most actively traded contracts on the stock of this particular company for the Dec. 16, 2024 trading day;

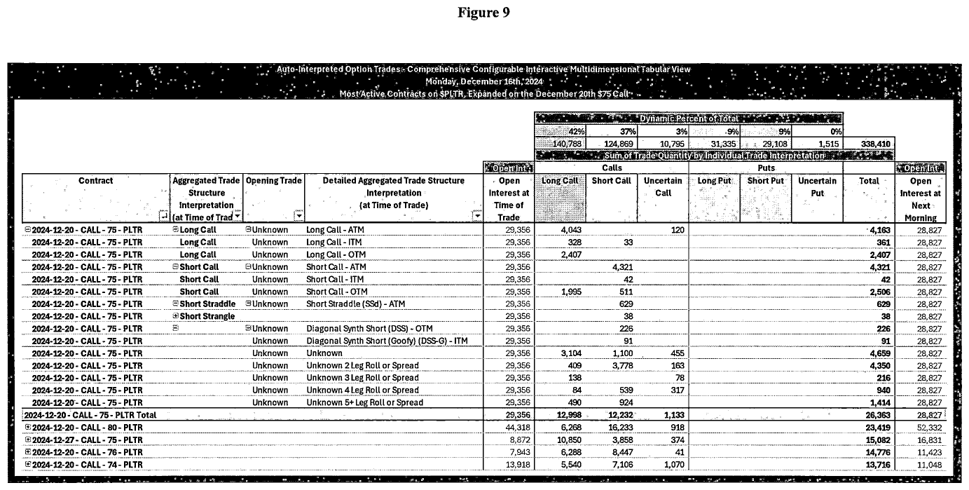

FIG. 9 illustrates the viewer tool filtered on a single underlying stock of interest, in this case $PLTR, and further expanded by clicking on a contract of interest to drill-down and explore how the automated interpreter component of the method and system has already categorized individual trades as well as identified apparent single-leg and multi-leg positions and/or rolls from the aggregation of related trades, resulting in a view that makes it very easy for the user to quickly hone in on the most interesting pieces of flow data while still seeing the full picture of activity on the contract, for the Dec. 16, 2024 trading day;

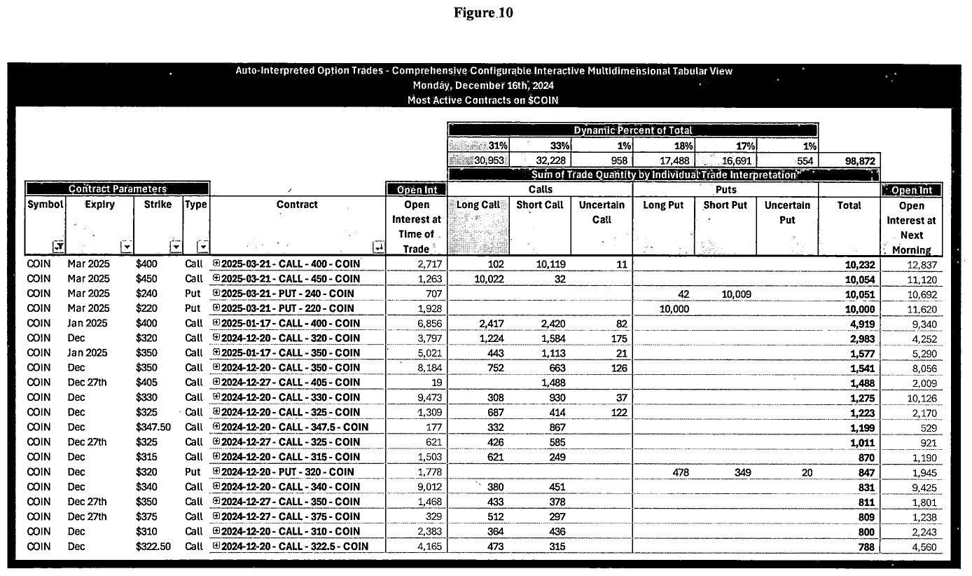

FIG. 10 illustrates the viewer tool filtered on a single underlying stock of interest, in this case $COIN, and sorted by total trade quantity in descending order, resulting in a view of the most actively traded contracts on the stock of this particular company for the Dec. 16, 2024 trading day;

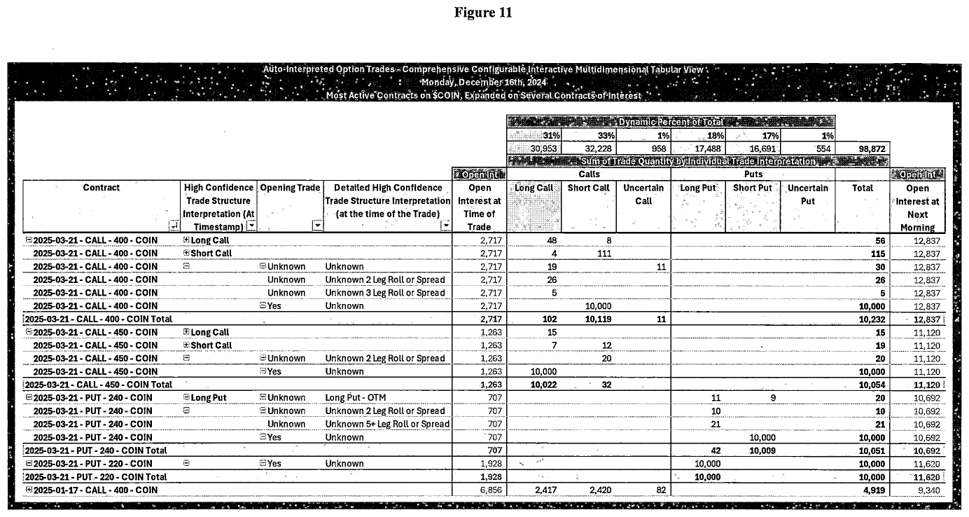

FIG. 11 illustrates the viewer tool filtered on a single underlying stock of interest, in this case $COIN, and further expanded by clicking on multiple contracts of interest to drill-down and explore how the automated interpreter component of the method and system has already categorized individual trades as well as identified apparent single-leg and multi-leg positions and/or rolls from the aggregation of related trades, resulting in a view that makes it very easy for the user to quickly hone in on the most interesting pieces of flow data while still seeing the full picture of activity on the contracts of interest, for the Dec. 16, 2024 trading day;

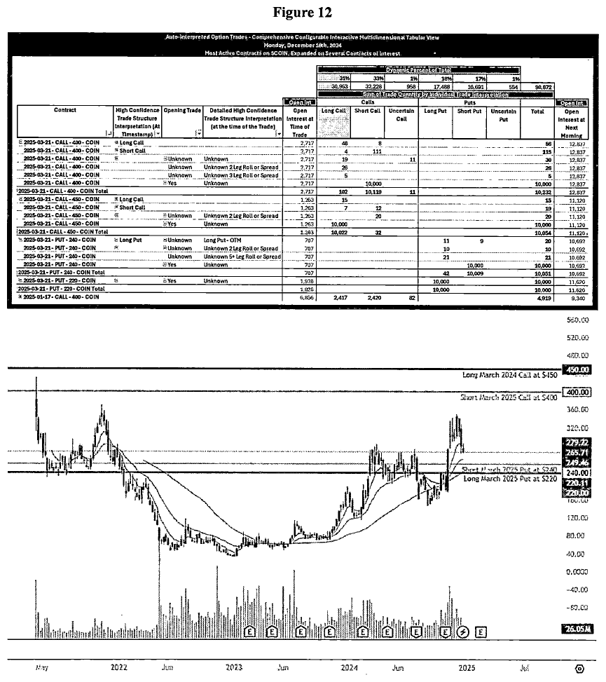

FIG. 12 includes the same image from FIG. 11 alongside a stock price chart with horizontal lines and text annotations on the face of the chart that bring to life the four-leg trade that is apparent in the tabular view.

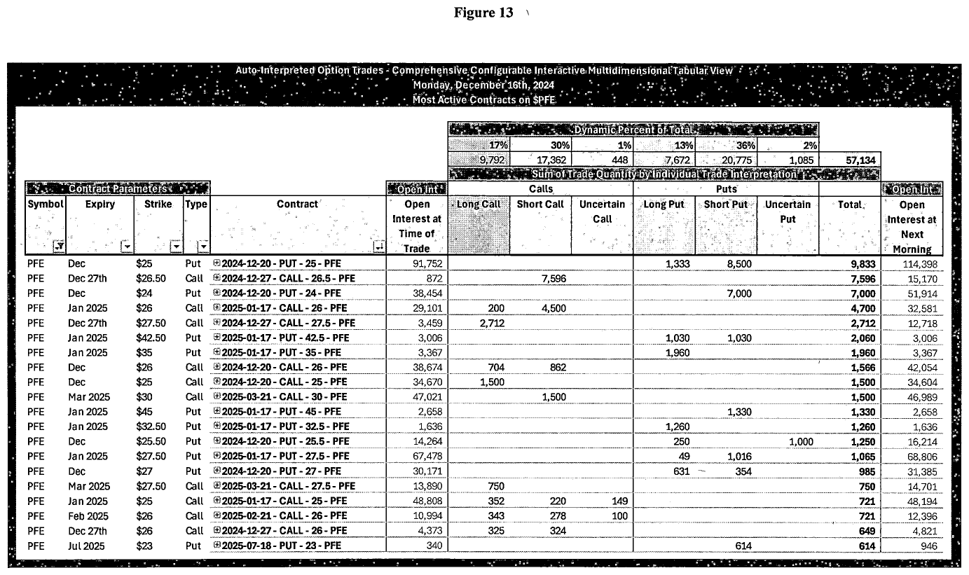

FIG. 13 illustrates the viewer tool filtered on a single underlying stock of interest, in this case $PFE, and sorted by total trade quantity in descending order, resulting in a view of the most actively traded contracts on the stock of this particular company for the Dec. 16, 2024 trading day;

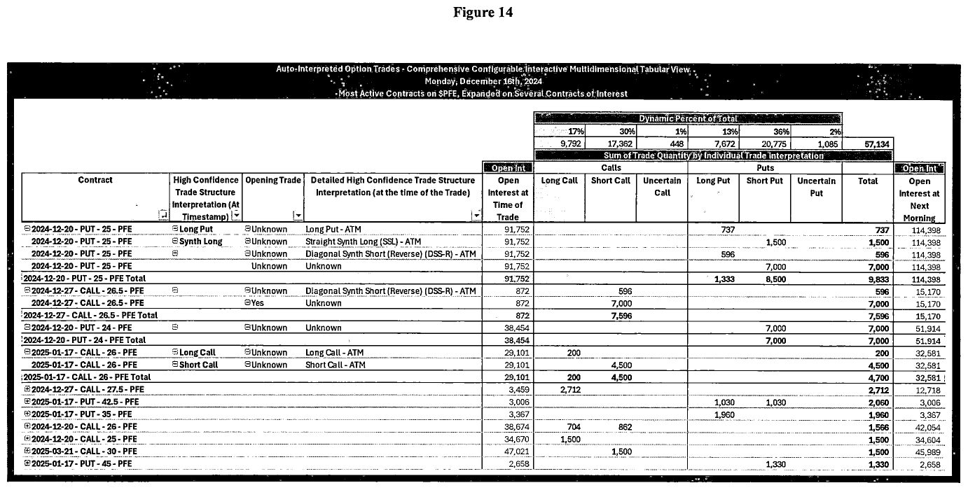

FIG. 14 illustrates the viewer tool filtered on a single underlying stock of interest, in this case $PFE, and further expanded by clicking on multiple contracts of interest to drill-down and explore how the automated interpreter component of the method and system has already categorized individual trades as well as identified apparent single-leg and multi-leg positions and/or rolls from the aggregation of related trades, resulting in a view that makes it very easy for the user to quickly hone in on the most interesting pieces of flow data while still seeing the full picture of activity on the contracts of interest, for the Dec. 16, 2024 trading day;

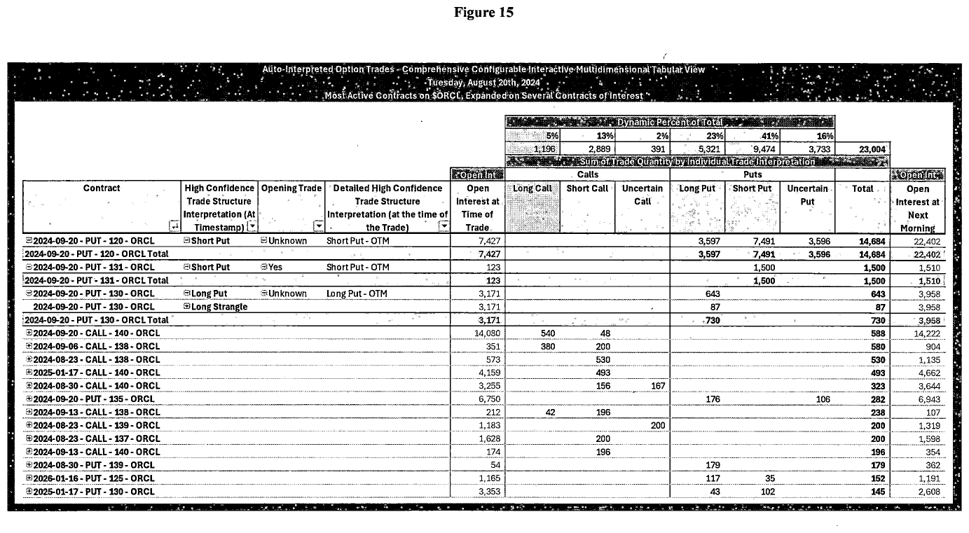

FIG. 15 illustrates the viewer tool filtered on a single underlying stock of interest, in this case $ORCL, and further expanded by clicking on multiple contracts of interest, for the Aug. 20, 2024 trading day;

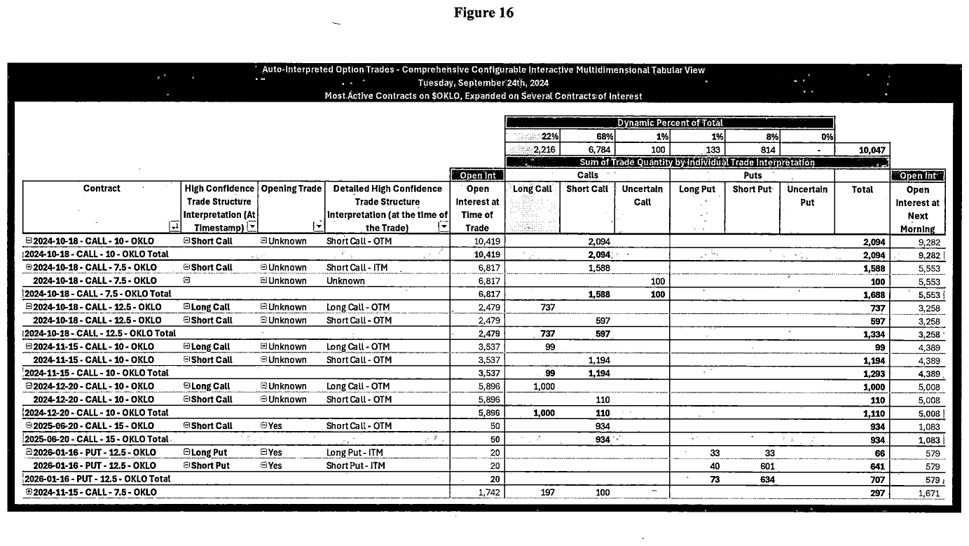

FIG. 16 illustrates the viewer tool filtered on a single underlying stock of interest, in this case $OKLO, and further expanded by clicking on multiple contracts of interest, for the Sep. 24, 2024 trading day;

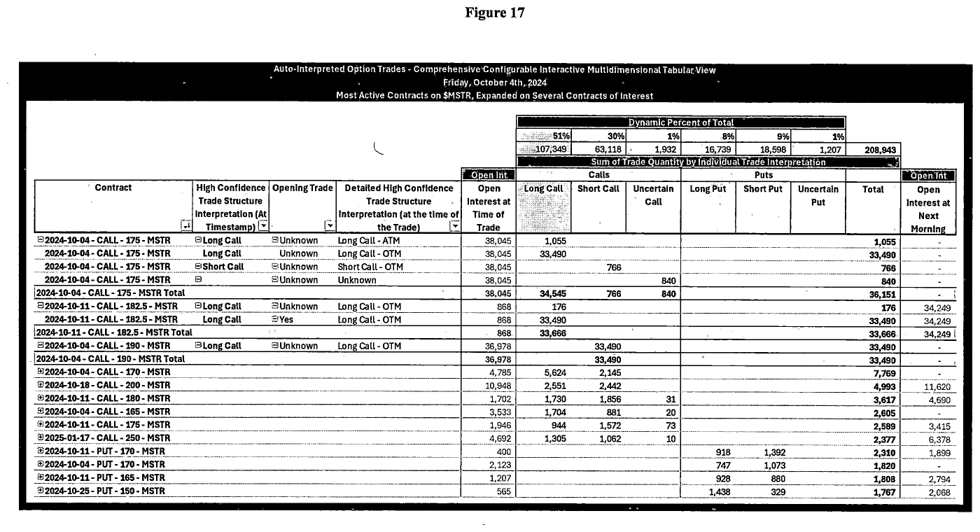

FIG. 17 illustrates the viewer tool filtered on a single underlying stock of interest, in this case $MSTR, and further expanded by clicking on multiple contracts of interest, for the Oct. 4, 2024 trading day;

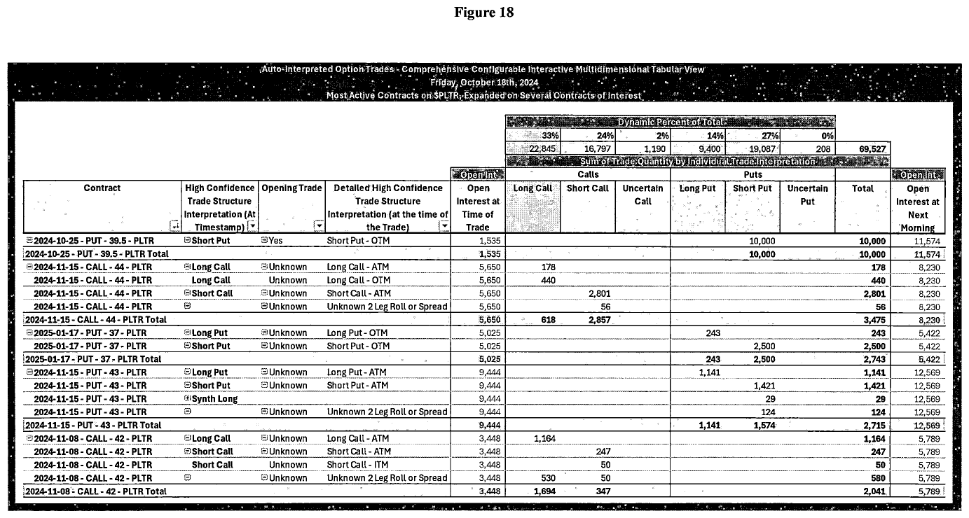

FIG. 18 illustrates the viewer tool filtered on a single underlying stock of interest, in this case $PLTR, and further expanded by clicking on multiple contracts of interest, for the Oct. 18, 2024 trading day;

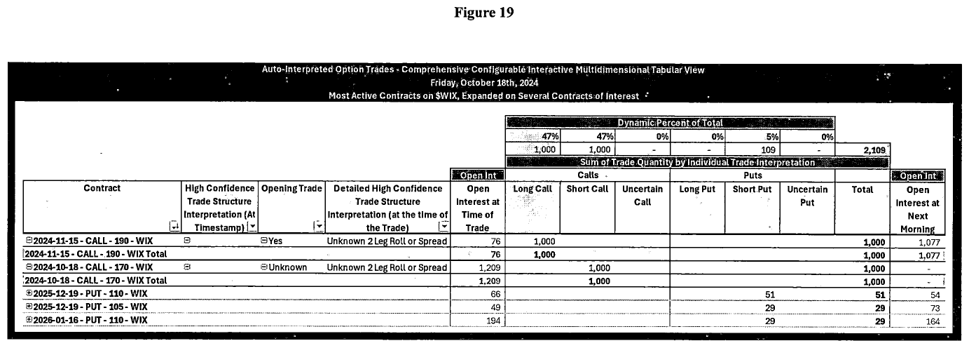

FIG. 19 illustrates the viewer tool filtered on a single underlying stock of interest, in this case $WIX, and further expanded by clicking on multiple contracts of interest, for the Oct. 18, 2024 trading day;

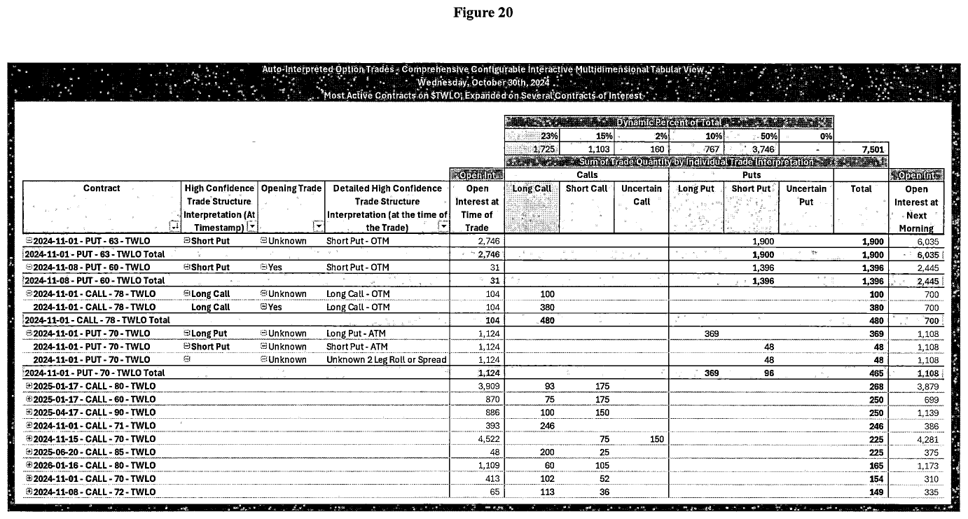

FIG. 20 illustrates the viewer tool filtered on a single underlying stock of interest, in this case $TWLO, and further expanded by clicking on multiple contracts of interest, for the Oct. 30, 2024 trading day;

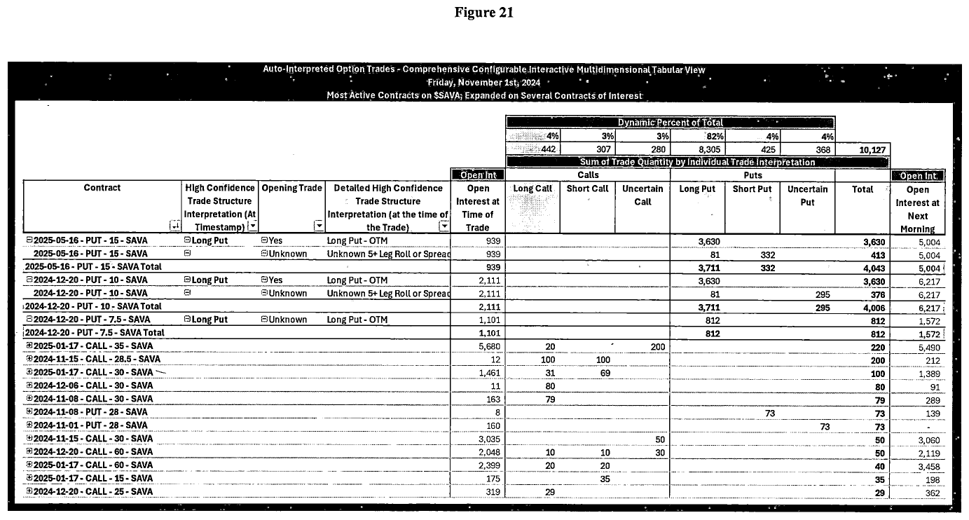

FIG. 21 illustrates the viewer tool filtered on a single underlying stock of interest, in this case $SAVA, and further expanded by clicking on multiple contracts of interest, for the Nov. 1, 2024 trading day;

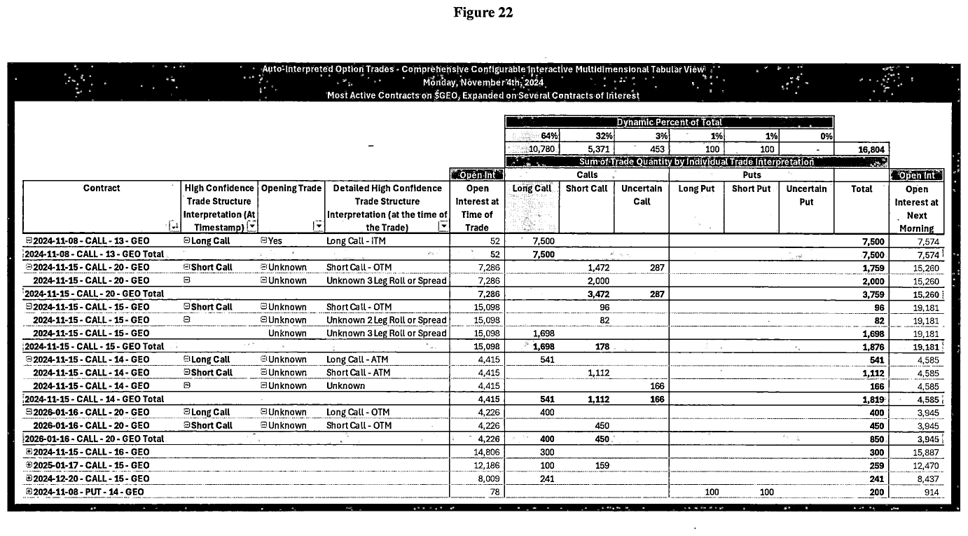

FIG. 22 illustrates the viewer tool filtered on a single underlying stock of interest, in this case $GEO, and further expanded by clicking on multiple contracts of interest, for the Nov. 4, 2024 trading day;

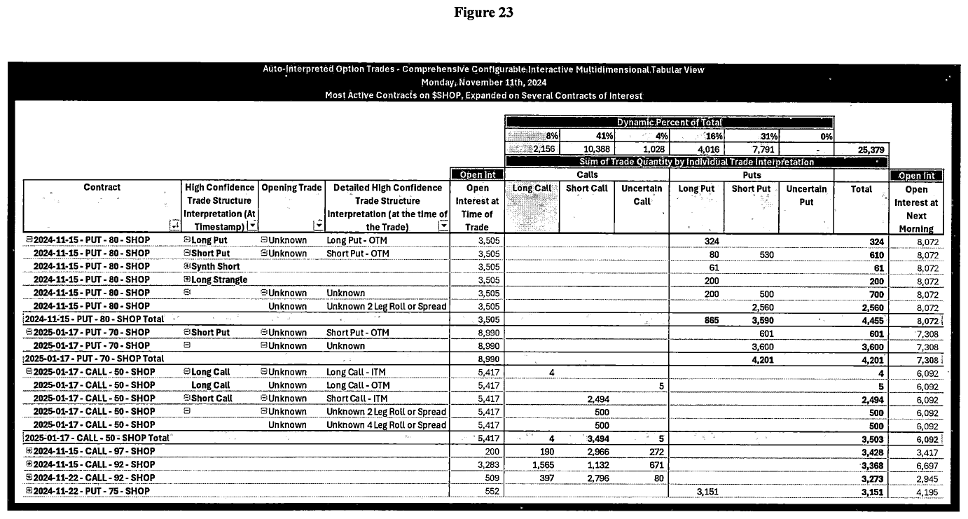

FIG. 23 illustrates the viewer tool filtered on a single underlying stock of interest, in this case $SHOP, and further expanded by clicking on multiple contracts of interest, for the Nov. 11, 2024 trading day;

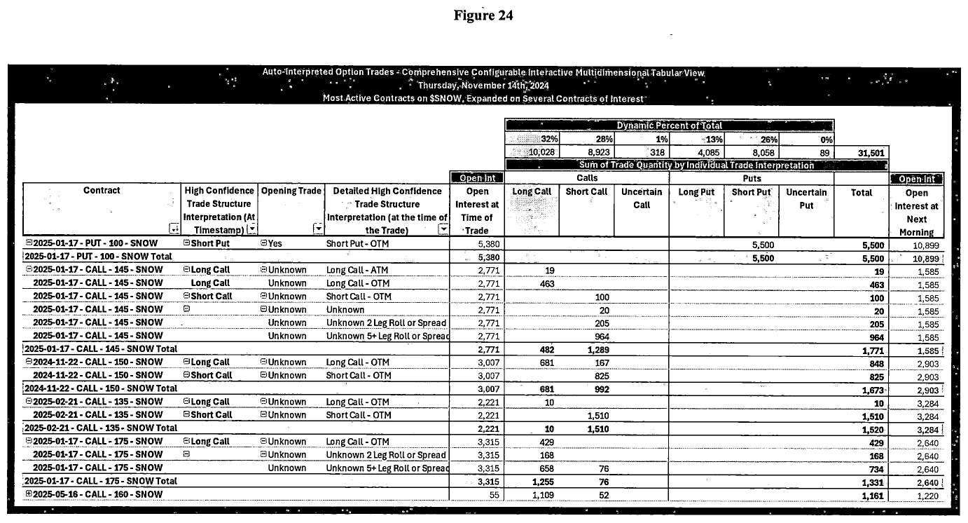

FIG. 24 illustrates the viewer tool filtered on a single underlying stock of interest, in this case $SNOW, and further expanded by clicking on multiple contracts of interest, for the Nov. 14, 2024 trading day; and

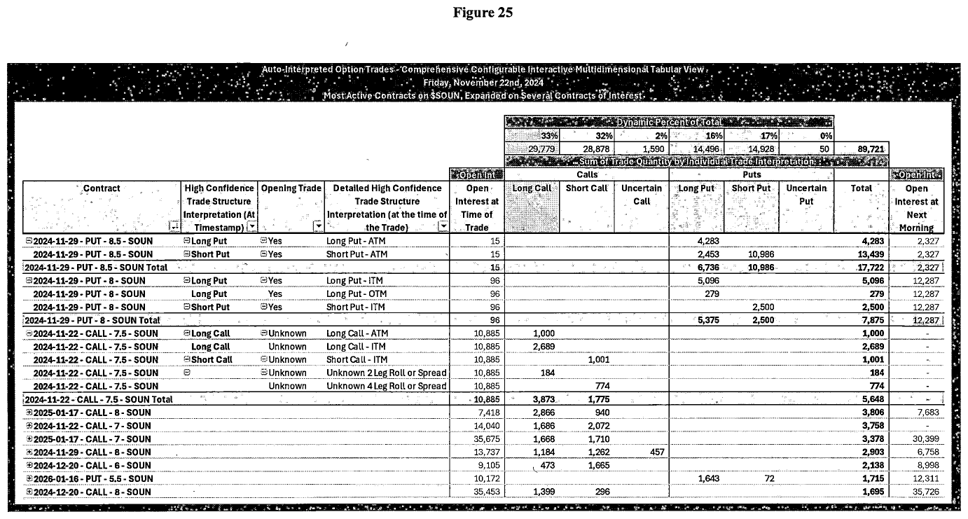

FIG. 25 illustrates the viewer tool filtered on a single underlying stock of interest, in this case $SOUN, and further expanded by clicking on multiple contracts of interest, for the Nov. 22, 2024 trading day.

### DETAILED DESCRIPTION OF THE EXHIBITS

### FIG. 1

FIG. 1 illustrates the data flow, processing and final product delivery architecture that is central to the invention. Raw data is transformed into a multidimensional structure in order to render the comprehensive and configurable interactive tabular view which is ultimately delivered to users by various means.

Raw Data Sources: the process begins with the ingestion of various datasets, including:

Option trades: Also known as “time & sales” data, these are the individual historical option transactions with as much execution metadata as possible which can ultimately be utilized in the directional interpretation and even included in the final user delivery, such as: contract components (underlying security ticker symbol, option type, expiration date, strike price), trade quantity, timestamp, exchange, execution method, trade conditions, implied volatility, and even trade ID and trader ID to the extent available.

Option quotes: These are the bid and offered prices and quantities recorded in the order book, of which we are most interested in what appeared at the moment of a given option trade. Similarly, as much metadata as possible is ideal, such as individual quotes by venue. This can become a large dataset because market makers maintain standing bids and offers on most contracts throughout the day, and those quotes can be updated with great frequency. Displayed order book data is also generally known to be manipulated at times to the advantage of sophisticated participants, so such data must be taken “with a grain of salt.” That said, this data can be informative to a directional interpretation, such as when very high quantities are recorded on only one side of the order book, or when options trade at or very near the mid price or on contracts with very narrow bid-ask spreads such as $0.01, causing a price-based interpretation to be potentially less informative.

Option open interest: As mentioned above, derivate instruments are traded in a contract market, like many sports bets. There is no fixed supply of these bets as there are with stocks; rather, there is only a designated structure of bets that may be placed, known as the option chain in this context, which is a list of all combinations of expiration date and strike price available on a given underlying security at a given time. Option open interest is integral to the inference of whether a given trade or group of trades was most likely to open or to close by the customer and whether the trade or trades in question were still outstanding the next day.

Reference data: Although the core functionality provided by this invention focuses on the automated interpretation of options trades and the subsequent exploration of that data via a highly empowering new viewer tool, the value of this activity is greatly enhanced by the inclusion of enriched time and sales data and also reference data. (Enriched data is described below.) Reference data encompasses attributes mostly about the underlying security, such as sector, industry, index membership, thematic group membership, fundamental attributes such as market capitalization, financial ratios and pricing multiples, and technical attributes such as 52-week high and low, moving averages, relative strength index (RSI), volume-weighted average price (VWAP), underlying historical stock volatility, underlying historical implied volatility, short interest, borrow fee rate, and so on. (Many of these technical datapoints could be readily computed directly using historical underlying stock price data by the system itself, but much of this data is readily available from existing third-party sources.) The inclusion of refence data allows the user of the final viewer tool to, among other things, sort and filter by these dimensions and synthesize how options are being traded across different groups of related securities or contracts with similar attributes. FIGS. 2 through 7 provide examples of this.

Other datasets: The claimed invention is not limited to only the four categories of raw data sources listed in the diagram; additional datasets of interest to the user and of relevance to the problem of efficient options flow interpretation may be relevant or come available over time, and the inclusion of such additional datasets is contemplated by the claimed invention.

ETL. Aggregation and Enrichment Process: Once all raw source data is obtained, all data of interest must then be imported and aggregated, which would include not only the raw external data but also enriched data that is generated from the raw data itself, such as derived metrics e.g. daily contract volume totals by underlying stock symbol. To perform this step, developers can use a scripting language or data preparation software or platform, such as Microsoft Power Query, Alteryx, Python, or even a standard SQL database tool. Such tools enabled a user to fetch and manipulate data from multiple sources, perform data cleansing, create relationships among tables, etc.

Aggregated and Enriched Multidimensional Data Storage: Once all data of interest has been prepared and generated, it must be stored in a single data warehouse so that all data of interest to the end user can be made available via the single configurable and interactive viewer tool at the end. A local or cloud based off the shelf multidimensional data storage solution meets the need here, but again could also be achieved using conventional local tools such as a standard SQL database application.

Enrichment refers specifically to the generation of additional columns of data based purely on the original raw source data, sometimes also known as “pre-calculated” columns. These columns are particularly important for ensuring the snappy and responsive data exploration experience for the end user, because pre-calculating and storing values that would otherwise likely need to be continuously recalculated over and over again eliminates the need to do just that. A great example of this is the calculation of trade quantity subtotals by underlying symbol and contract, which are not naturally included in a raw data table of only trades.

Generation and Delivery of Final User View Process: With all data of interest prepared and available from a single multidimensional source system, the “front-end” tool or graphical user interface (GUI) can be created and loaded with the relevant data for distribution. In the options analysis context, even interpreted and aggregated data can span hundreds of thousands of rows for a single day of activity, so the natural delivery to user would be a daily dataset and perhaps also a weekly dataset. However, the contemplated invention is not limited in any way by iteration frequency or data scope, which will depend on computing power and delivery method between the service and the end user devices. To the extent that real-time data and/or monthly or annual or inception to date data can be provided, this invention does contemplate and encompass that potential future delivery frequency and data size.

Delivery Mechanisms: Different users may prefer different delivery mechanisms, and only some delivery mechanisms may be feasible for some delivered dataset sizes. The most naturally apparent delivery methods today would include email attachments, downloads from a website, in-browser application, desktop application, and mobile application. That said, the claimed invention is not limited to only these five categories of delivery mechanism listed in the diagram; additional delivery mechanism may come available over time, and the inclusion of such additional delivery mechanism is contemplated by the claimed invention.

Comprehensive Configurable Interactive Tabular View: Finally, what the end user receives or obtains access to is the central feature, a fully enabled, fully loaded and snappy data exploration experience that is highly empowering in the field of options activity interpretation and analysis and flow-based trade idea generation.

For the avoidance of doubt, programming and/or business intelligence skill or resources would be necessary to independently create and implement the invention, which is something that some but not all persons of ordinary skill in the art of options flow interpretation may or may not possess or have reasonable access to. However, the end users including all persons of ordinary skill in the art of options interpretation that the invention is intended to serve do not need such skill to make productive use of the viewer tool because it is derived from the very end of the process; only the final work product, ready for analytical consumption, is delivered, relieving the user from any work or burden related to the method and system that produces the final viewer tool. FIGS. 2 through 25 are direct illustrations, essentially snapshots of, the comprehensive configurable interactive multidimensional tabular view, referred to henceforth as the “viewer tool” for brevity, as it would appear to the user in the moment of use. These snapshots were generated using the viewer tool set to only include large option trades, also known as “block” trades, defined here as individual trades involving no less than $10,000 of contract notional value, in order to better bring the use case to life and draw the eye to the activity that is typically often sought. Many users would naturally prefer this setting as opposed to filtering on all option trades or even on only small option trades, in pursuit of what is often referred to as the “smart money.” That said, for the avoidance of doubt, the invention contemplates the user ability to include and exclude trades of any size, just as with any other dimension, as explained further below.

FIGS. 2 through 8 illustrate various configurations of the viewer tool as it would be used to explore the most actively traded contracts on the trading day of Monday, Dec. 16, 2024. FIG. 8 includes red arrow and circle annotations to specifically illustrate how the user would use a mouse to point and click on the tool to modify the displayed rows and columns, apply filters, sort data, and expand or collapse rows of interest. These are intended to show how the viewer tool has great flexibility and can be utilized to comprehensively explore all options data on a given trading day.

FIGS. 9 through 25 illustrate one of the most natural configurations of the viewer tool for several specific underlying stocks and trading days in which those stocks had noteworthy options activity. These are intended to show how the viewer tool would be used to unpack noteworthy or unusual options activity of interest, how a practitioner would likely interpret the information, and briefly touch on potential trading outcomes based on subsequent underlying stock price action.

The first 20 rows of each view are included, but for the avoidance of doubt the user is also able to scroll up and down the full list of contracts and trades in scope for the configured view.

### FIGS. 2 and 3

FIGS. 2 and 3 illustrate a snapshot of the viewer tool configured to filter the interpreted options flow data exclusively for single-name stocks and multi-name products, respectively (the latter being ETFs, closed-end funds, etc.) The data is sorted by total trade quantity in descending order, enabling the user to quickly identify the most actively traded options contracts on single-name stocks or multi-name products, respectively, for the trading day of Dec. 16, 2024.

As mentioned, there is only so much real estate on a screen, and although the user must have as much dimensional data as possible at their fingertips and within view during the moment of analytical consumption for maximum value, it is generally impractical to display and consume all columns at once. The user will naturally select certain columns to include and exclude for a given inquiry, which are shown on the left-hand side. The columns on the right-hand side, beginning with Open Interest at Time of Trade, and ending with Open Interest at Next Morning, will generally remain displayed in this context. The columns displayed are:

Stock Type Bifurcation: Allow the user to easily separate between options traded on single name stocks and options traded on multi-name products, a common binary distinction in the art. Both are generally of interest to a trader, but are typically analyzed separately. This is a strong example of the value of bringing configurable reference data to the fingertips of the user at the point of analytical consumption.

Contract: Lists each option contract, presented as a hyphen-concatenated string of the four main option contract components, in order to preserve readability in the column: expiration date, option type, strike price, and underlying stock symbol. The invention also contemplates a vernacular version of the Contract column, in which the contract value would be displayed more so as a trader might write out the contract themselves naturally; rather than “2025 Jan. 17-CALL-40-EEM”, a trader identifying this contract on the day of Dec. 16, 2024 might refer to this as the “EEM Jan $40 C”.

Open Interest at Time of Trade: The importance of open interest has been described in detail above. Initial open interest, trades for the given day, and finally subsequent morning reported open interest, are shown in that order, from left to right, as the user's eye naturally moves from top to bottom and from left to right across the tabular view.

Trade Quantities: These columns show the number of contracts traded, categorized into the four main possible individual trade interpretations. Each individual option trade must ultimately be either a buy or a sell of a call or a put. Also, when option trades are simply not inferable, such as when an option trades at the pure mid price, with equal bid and offered sizes on each side of the order book, with no change in implied volatility, no change in underlying stock price, no apparently related stock block trades, etc., these are simply presented separately as “Uncertain” call and put trades. Contract total quantity traded is also shown. Since a user might have to scroll up and down to see all trades in scope, a dynamic percentage of total provides the user with continuous perspective on the mix of activity meeting the given criteria. Color is utilized selectively: long call and long put are paired with darker green and darker orange, respectively, while short call and short put are paired with lighter orange and lighter green, respectively. This is because buying an option is generally considered to be more directionally aggressive, or at least more aggressive on the future volatility of the underlying stock, than selling an option. Strategic use of soft colors generally enhances readability and interpretability, especially as parts of the view are constantly changing as the user is exploring.

Open Interest at Next Morning: The importance of open interest has been described in detail above. Initial open interest, trades for the given day, and finally subsequent morning reported open interest, are shown in that order, from left to right, as the user's eye naturally moves from top to bottom and from left to right across the tabular view. When the user is examining the data for the current trading day, before that day's closing open interest has been reported, this column simply will be blank.

On this particular day, we can see that $NVDA and $TSLA were by far the most actively traded underlying stocks using options, which is not at all unusual at this time. Puts were less common among the most actively traded single name contracts here, so a trader's eye might jump to the short puts written on $NVDA, especially the deep in-the-money and shorter expiration $142's, an unusual choice.

Among multi-name products, we can see $EEM and $FXI, two popular emerging markets ETFs, dominating the tape with very high call volume. Interestingly, there is almost no open interest reported on these contracts the next morning after all of that volume. A knowledgeable practitioner could quickly guess the reason: both ETFs had their semiannual dividend payments the next day, so this heavy options activity was most likely related to dividend arbitrage. Without this viewer tool, it might take a newcomer to the study of unusual options activity many days of manual interpretation and market study to pick up on this nuance.

### FIGS. 4 through 7

FIGS. 4 through 7 illustrate snapshots of the viewer tool as it may be configured by users looking for activity on contracts meeting certain criteria. Some contracts effectively offer more leverage than others, so some traders will simply look for underlying stocks that are receiving the most aggressive option flow, rather than starting from a set of underlying stocks of interest and waiting for compelling flow to appear on them.

FIG. 4 illustrates a snapshot of the viewer tool configured to filter the interpreted options flow data exclusively for contracts on single name stocks having between 10 and 45 DTE. Shorter-dated options generally carry greater risk of loss than longer-dated options, but cost less to deploy because less time value is purchased, and thus offer greater leverage. The Expiry Type and DTE columns allow the user to filter the view with ease.

FIGS. 5 and 6 illustrate snapshots of the viewer tool configured to filter the interpreted options flow data exclusively for out-of-the-money (“OTM”) call contracts on single-name software stocks, and for 10% or further in-the-money (“ITM”) put contracts on single name stocks with 20 or fewer DTE, respectively. Moneyness, or the distance between the option strike price and current stock price, is another means of gauging the probability of success of an option position and effectively leverage provided by the contract. Some traders focus on specific sectors and industries, and some traders specifically look for option type and moneyness status combinations. The Moneyness Status and Moneyness Percent columns allow the user to filter the view with ease.

FIG. 7 illustrates a snapshot of the viewer tool configured to filter the interpreted options flow data exclusively for contracts on single name stocks having a market capitalization of less than or equal to $1 billion, i.e. “small cap” stocks.

### FIGS. 8 and 9

FIGS. 8 and 9 provide our first look into the options activity for a single underlying on a specific day, one of the most natural use cases for the viewer tool. FIG. 8 includes red arrow and circle annotations to specifically point out how the user is intended to interact with the viewer tool by using a mouse, keyboard or other means to point and click to filter, sort, include and exclude columns, and expand and collapse rows of interest.

FIG. 8 shows substantial options activity on $PLTR for the day, but not much stands out on the surface. Calls are dominant, but roughly equally split between calls bought and calls sold. Without having to leave the view, the user can click to expand the activity on the single most actively traded contract, in this case the December $75 call. FIG. 9 shows what the user would see following this click to expand rows and drill down into the contract of interest.

As mentioned above, individually interpreted option trades can be aggregated into a single interpretation depending on the granular raw trade data. The three “Short Call” rows provide a nice example of this. The data is broken up into when the given contract was ITM, ATM or OTM during the trading day, but the aggregation test by contract is applied independent of moneyness status. In total, 6,869 trades were identified as a single short call, i.e., a sale of a call option. However, of these, 1,955 would have been identified as call purchases if analyzed individually. How can this be the case?

It is because the auto-interpreter is providing another service that traders must perform themselves manually today. As mentioned above, some orders are filled in multiple executions, sometimes in rapid succession. When a high frequency trading algorithm is filling an order in multiple executions, and especially when it does so very rapidly, all other high frequency systems are responding to the burst of action and seeking to adjust their own quoted prices and quantities as quickly as possible. The result is that bid and offered prices and quantities, implied volatility, the underlying stock etc. are all moving in the moment that the large order is being filled, resulting in a flurry of motion in the data. When this occurs, even though a single order to buy say 10,000 contracts is being filled, some of the individual trades when analyzed on a standalone basis can appear to be a sale of contracts. This is what the auto-interpreter is telling us on the 6,860 Short Calls here. If analyzed individually, 1,995 of those calls would be interpreted as purchases, but the trades in scope had similar attributes, such as timestamp and/or common execution criteria, that provided a sufficient basis on which to relate the trades for aggregate analysis. The majority of the quantity traded were short calls, so the method and system interpret the full quantity as a short call. The detail is there for the trader who wants to explore it, but the aggregation delivers a significant efficiency of interpretation in this regard that contemporary tools do not.

### FIGS. 10 through 12

FIGS. 10 and 11 provide another look into the options activity for a single underlying on a specific day.

FIG. 10 shows substantial options activity on $COIN for the day, and immediately something sticks out to us. We can see 10,000 of size traded on four different contracts, much more than the total traded on even the next most actively traded contract with less than 5,000 of volume. FIG. 11 shows what the user would see following the click to expand all four contracts with the significant volume on them.

Here we see another excellent use case for the tool. The user must make sense of four large equally sized trades across the chain. All four are most likely opening trades based on that fact that the individual trade quantity exceeds the published open interest at the time of the trade, and this is further confirmed by the fact that the subsequent morning open interest was at least 10,000 for each contract. A light-yellow highlight draws the user's eye to the opening trades.

The viewer tool is making it very apparent to the user without having to perform themselves the laborious manual interpretation of raw trade data to infer what is happening. With $COIN stock trading at $315 at the time of the trade, the option trader here is simultaneously deploying both a put spread and a call spread, both new i.e. to open. The interpreter is telling us that the trader is selling the OTM put spread (somewhat bullish) and selling the OTM call spread (somewhat bearish). The OTM put spread is bullish in the sense that it is “betting on a price floor”, but that floor price is pretty far below the current stock price. The OTM call spread is bearish in the sense that it is “betting on a price ceiling”, but that price ceiling is pretty far above the current stock price. Some traders might also interpret this structure contrary to the findings of the auto-interpreter, and instead consider it to be a “funding trade”, whereby the put spread is sold in order to generate some capital to fund the purchase of a bull call spread. This is possible, but herein lies another valuable feature of the auto-interpreter. There will always be some option trade interpretations that are very close or tough to call with absolute certainty, such as where there is only a sliver of evidence to support the argument that a given individual trade is a purchase or sale of an option and to open or to close. Even the most systematic approach is no crystal ball and will not correctly interpret 100% of all option trades. However, a systematic approach not only relieves the user of manual interpretation but also removes user bias from the interpretation process. In this case, it can prevent a trader who might otherwise have had an ex-ante bullish bias for $COIN from potentially misinterpreting a significant piece of noteworthy options activity.

This example also provides an excellent use case for the automated rendering of key price levels implied by options activity directly onto a stock price chart, which again traders do today either mentally themselves and attempt to store in their personal memory or input themselves manually into a charting software package. FIG. 12 illustrates this for this four-leg option trade on $COIN.

### FIGS. 13 and 14

FIGS. 13 and 14 provide another look into the options activity for a single underlying on a specific day.

FIG. 13 shows substantial options activity on $PFE for the day, and immediately something sticks out to us. We can see a number of round-number thousand-contract size trades across the board. Already, this suggests institutional activity without much accompanying retail activity, which some would view by itself as a favorable indicator of a chance to get in early on an impending move.

FIG. 14 shows the expansion of several contracts of interest. The appearance of 7,000 of volume on three different contracts suggests a spread trade or roll transaction, but the auto-interpreter is not picking up any such multi-leg transaction, so the trades must not have close timestamps or other sufficient criteria to merit relating the trades for aggregate interpretation. If the trader wishes to investigate the raw trade data, they can do so next, but part of the efficiency and value of the system and method flows from becoming familiar with the auto-interpreter and running with its findings.

From here, we can look to the dynamic percentage of total and the strike prices being traded. Overall, options are being sold on $PFE. Further, the puts are being sold around $25 and the calls are being sold around $26 and $26.5, a very tight range. This action suggests that the market expects $PFE stock to remain relatively rangebound and settled within this price area for the next month or so. Selling options on a stock that has just experienced a major move and still has that recent historical realized volatility influencing its' present options prices can create compelling option trades to profit even from a stock that is settling down and going nowhere fast.

### FIG. 15

FIG. 15 provides another look into the options activity for a single underlying on a specific day, specifically $ORCL on Aug. 20, 2024.

Here we see that the preponderance of activity on the day is on the put side, and most of that is OTM put selling. Put writing is a common tactic for trading the stocks of large and mature companies with a bullish bias, because these are well understood and closely followed companies; as such, their stocks are less likely to move very high and very rapidly in price, as for instance might the stock of a lesser-known, younger, high-growth technology startup company on a compelling headline. Rather than betting that $ORCL stock will rise rapidly, a trader can simply bet that the stock will not fall below a certain level.

Within 1 month of this noteworthy options activity, $ORCL stock rose as high as +25.0% following a favorable price response to its' Sep. 9, 2024 earnings release, outperforming the $SPY S&P 500 index ETF over that period by no less than 22.5%.

### FIG. 16

FIG. 16 provides another look into the options activity for a single underlying on a specific day, specifically $OKLO on Sep. 24, 2024.

Here we see that the preponderance of activity on the day is on the call side, and most of that is OTM call selling. OTM call selling is a common tactic for investors who are accumulating common stock for the longer term and willing to sacrifice some near-term upside in exchange for option premium today that is used to offset the cost of their common stock investment. Many practitioners would ultimately consider this to be a bullish activity even if more of a long-term signal that suggests limited nearer-term upside potential.

Although many of the speculative nuclear small modular reactor stocks had strong price performance during the 4^{th} quarter, this one was no exception. Within 1 month of this noteworthy options activity, $OKLO stock rose as high as +175.9%, outperforming the $IWM Russell 2,000 index ETF over that period by no less than 173.2%.

### FIG. 17

FIG. 17 provides another look into the options activity for a single underlying on a specific day, specifically $MSTR on Oct. 4, 2024.

Here we see that nearly 35,000 calls were purchased to open on the October $182.5 contract. Although the interpreter is not catching it as such and for reasons explained above, this trade appears to be complex roll. The trader is rolling from a $175/$190 call spread expiring that day to the $182.5 call expiring the following week. It would be nice if the interpretation of the spread were clearer here, but it is the future that matters most. The trader is going from a spread to an unlimited upside position, and not reducing quantity at all. The price of $MSTR stock had been rising nicely, and the trader expects more of the same. They are choosing to “let the winner run” as they say in the art. We can also see that the selected strike price of $182.5 aligns nicely with recent highs on the daily stock price chart. Although we can never be certain of a market participant's total portfolio and it is well known that some traders will purchase and maintain a long call position while they are working their way out of a large common stock position, this trade size is large enough to be not likely a “decoy” of sorts.

Although $MSTR has become essentially a leveraged long bitcoin vehicle and bitcoin performed strongly over the 4^{th} quarter, this action did not disappoint. Within 1 month of this noteworthy options activity, $MSTR stock rose as high as +51.8%, outperforming the $QQQ Nasdaq 100 index ETF over that period by no less than 48.9%.

### FIG. 18

FIG. 18 provides another look into the options activity for a single underlying on a specific day, specifically $PLTR on Oct. 18, 2024.

Here we see some fairly balanced daily activity considering the percentage of total by individual trade interpretation displayed across the top of the viewer tool, but the single 10,000 lot short put trade to open in the October 25^{th} $39.5 strike OTM puts at the top of the list is impossible to miss using this view. Although there are many traders of options in the market, the biggest participants naturally have sway and their trades will grab more attention. Going back to the idea of the panoply of possible strike and expiry combinations that a trader has at their disposal; volume naturally tends to cluster on the standard monthly expiries and on the round number strikes because that is where one is likely to find liquidity. But here the trader has chosen an off-week contract and a peculiar strike price, just $0.50 below a major round number strike price. Intentional selection of a lesser-traveled contract is a classic indication of precision of expectations on the part of the trader.

Within 1 month of this noteworthy options activity, $PLTR stock rose as high as +53.6%, outperforming the $SPY S&P 500 index ETF over that period by no less than 50.9%.

### FIG. 19

FIG. 19 provides another look into the options activity for a single underlying on a specific day, specifically, $WIX on Oct. 18, 2024.

Here we see some 1,000 lot trades on a stock that has recently attracted very little options activity at all. This is noteworthy already because thinly traded options generally come with higher bid-ask spreads, and this trader is willing to pay the price of crossing that wide spread in order to gain their desired exposure to $WIX. This time, the auto-interpreter can clearly infer that the trade is a roll, and the contracts traded align with the individual trade interpretations of such a roll. The trader is selling their 1,000 October $170 calls in order to buy the same quantity of November $190 calls. The trader is buying time, paying up additional premium to maintain a position of the same size. Since the stock has been moving sideways for some time prior to this options activity, viewing the glass half empty, some would consider this “loser management,” deploying more money to bet on a move that failed to occur the first time. Viewing the glass half full, this roll can also be interpreted as an indication of confidence or conviction in the trade, in part because trade quantity is not reduced at all. The increase of strike price, although lowering the cost of the new leg, is a further-out bet with a lower probability of success but higher reward if correct.

Within 1 month of this noteworthy options activity, $WIX stock rose as high as +10.7%, outperforming the $QQQ Nasdaq 100 index ETF over that period by no less than 6.5%. Several days later, $WIX stock jumped another roughly +15% in response to a favorable earnings release.

### FIG. 20

FIG. 20 provides another look into the options activity for a single underlying on a specific day, specifically $TLWO on Oct. 30, 2024.

Here we see another stock that attracts relatively light options activity. This was also the last day before the company's impending earnings release. Among the light activity however was some heavier OTM put selling, including some written to open. The stock gapped up $10 the next day following the earnings release and proceeded to nearly double over the rest of the 4^{th} quarter.

Within 1 month of this noteworthy options activity, $TWLO stock rose as high as +53.7%, outperforming the $QQQ Nasdaq 100 index ETF over that period by no less than 49.8%.

### FIG. 21

FIG. 21 provides another look into the options activity for a single underlying on a specific day, specifically $SAVA on Nov. 1, 2024.

Here we have some compelling bearish options activity. During a time when many stocks and groups are performing strongly, someone is stepping up to the plate to buy several thousand OTM puts on $SAVA, a controversial yet highly popular biotech stock with impending clinical trial results at the time. The auto-interpreter is finding that the two large trades for 3,630 contracts each are both purchases of puts, but it is not unlikely that they could comprise a spread trade. The two contracts have pretty well spaced-out expirations and strike prices. If the trade is indeed a spread, we would have to assume that at least one of the two legs was actually a short put. If the May 2025 $15 puts are the short leg of a spread, someone is calling a floor at $15, but that is still well below the current stock price of about $26 at the time of the trade—not bullish by any means. If the December 2024 $10 puts are the short leg of a spread, then the trader is betting that price will land somewhere between $10 and $15 and probably closer to $10—also not bullish by any means. Thus, zooming out, it is hard to categorize this activity as bullish despite the inconclusiveness of the trade interpretation, and a compelling trading opportunity is revealed nonetheless. Without the viewer tool, a trader would have spent much more time and energy manually analyzing the raw trade data to assemble this picture.

Within 1 month of this noteworthy options activity, $SAVA stock collapsed to as low as $3.77, or negative 85.6%, following the release of unfavorable clinical trial results, and underperforming the $XBI S&P Biotech index ETF over that period by no less than 77.0%.

### FIG. 22

FIG. 23 provides another look into the options activity for a single underlying on a specific day, specifically $GEO on Nov. 4, 2024.

Here we see some healthy option volume and right at the top, a clean purchase of 7,500 ITM calls expiring the same week. ITM calls are an unusual choice for such a “short fuse” trade because they behave more like common stock than the more typical OTM call in terms of their return potential, since they require relatively more capital to deploy. But the willingness to choose the higher capital requirement contracts and to do so on a weekly expiration is indicative not only of size but also sophistication. $GEO released favorable earnings results two days later and the stock price proceeded to double.

Within 1 month of this noteworthy options activity, $GEO stock rose as high as 108.5%, outperforming the $IWM Russell 2,000 index ETF over that period by no less than 97.2%.

### FIG. 23

FIG. 23 provides another look into the options activity for a single underlying on a specific day, specifically $SHOP on Nov. 11, 2024.

Here we have a view that illustrates the value of the viewer tool to a trader in a nuanced way. $SHOP recorded the presented options activity on the day prior to its earnings release. We can see that some OTM puts were sold not too far below the spot price, which is generally bullish ahead of earnings, but some ITM calls were also sold. We cannot be sure that either of these trades were opening due to the open interest being greater than trade quantity on the relevant contracts. We do have one trade that is likely opening, the purchase of the 3,151 November 22nd $75 puts, which certainly appears bearish. What crystallizes here is that multiple parties are getting involved in the stock, but there is not consensus among them over what happens next. Although this can cause price to move sideways, it can also indicate that one side is about to be right and the other painfully wrong. Seeking trading opportunities such as these is even more analytically intensive because the trader must analyze multiple trades in order to discover such situations of disagreement appearing in the market, rather than simply running with compelling individual trades.

$SHOP stock gapped up 19.5% the next morning and within 1 month of this noteworthy options activity rose as high as +34.1%, outperforming the $QQQ Nasdaq 100 index ETF over that period by no less than 30.9%.

### FIG. 24

FIG. 24 provides another look into the options activity for a single underlying on a specific day, specifically $SNOW on Nov. 14, 2024.

Here we have another large block sale of OTM puts written to open ahead of an earnings release that stands out from all other top activity by contract for the day, even though the underlying stock appears to have a balanced mix of bullish and bearish flow looking at the percentages of total across the top of the viewer tool. $SNOW released favorable earnings results the following week and the stock gapped up nearly $30.

Within 1 month of this noteworthy options activity, $SNOW stock rose as high as 44.6%, outperforming the $QQQ Nasdaq 100 index ETF over that period by no less than 39.8%.

### FIG. 25

FIG. 25 provides another look into the options activity for a single underlying on a specific day, specifically $SOUN on Nov. 22, 2024.

Here we can see fairly evenly distributed call activity on this popular artificial intelligence stock, but then large opening trades on near-the-money puts expiring the following week. The emergence of size in the short-dated puts on a name that would otherwise only be expected to attract retail call flow is compelling by itself. We can also see from the subsequent day open interest that most of the $8.5 puts did not stick, but most of the $8 puts did stick. Among the $8 puts, the auto-interpreter found that most of these were puts bought, but the near-the-money weekly puts on an active speculative name will generally have decently tradeable bid-ask spreads, and sophisticated participants will have the ability to negotiate or otherwise obtain favorable fills such as by algorithmic sweep. At the very least, this options activity would have said to the trader, “This options activity may not be directionally conclusive, but you should pay close attention to this stock now.” The subsequent classically bullish price action would have compelled many traders to at least take a position, and those who took the trend as their friend would have been successful.

Within 1 month of this noteworthy options activity, $SOUN stock rose as high as 191.9%, outperforming the $IWM Russell 2,000 index ETF over that period by no less than 189.3%.

The last exhibits were consciously selected not only to further display the use of the invention but also to demonstrate the value that it brings to traders. Of course, there are many trades like these in the options market every day, and not every one will result in such large winners. But clearly, just one of these larger winners can pay for many losers, and then some, for a trader who is leveraging the power of the tool to efficiently evaluate many items of noteworthy options activity per day.

### CONCLUSION

This utility patent application has sought to illustrate the problem of efficient options activity interpretation by conventional means, to demonstrate the novelty and non-obviousness of the claimed invention, to teach the patent, and to assert the claims clearly and succinctly. The described method and system and exhibited embodiments show the value of the comprehensive configurable interactive multidimensional tabular view in context, and how a person of ordinary skill in the art would go about using it or building one. The invention culminates in a compelling new tool and way of working made possible by the new tool that brings significant newfound productivity to options activity-oriented traders.

what is claimed is:

1: A method for processing and analyzing options trading data, comprising:
receiving options trading data comprising parameters including strike price, expiration date, and trade volume;
enriching the received data with reference data and derived metrics, including underlying stock attributes and aggregated trade volumes;
storing the enriched data in a multidimensional structure;
generating a configurable interactive tabular view of the enriched data using the multidimensional structure; and
enabling a user to perform interactive data exploration operations, including but not limited to sorting, filtering, grouping, and drilling down into specific trades, wherein the method facilitates the identification noteworthy and actionable options activity, including multi-leg spread trades and roll transactions.

2: The method of claim 1, further comprising:
displaying dual open interest columns in the interactive tabular view, where one column represents open interest as of the time of the trade and another column represents subsequent-day open interest.

3: The method of claim 1, further comprising:
displaying trade directional interpretations at multiple levels of granularity, including individual trade interpretations and aggregated trade interpretations, within the interactive tabular view.

4: The method of claim 1, further comprising:
automatically overlaying options trading activity on a stock price chart, displayed alongside the interactive tabular view in a vertical or horizontal layout, wherein selected strike prices and/or expiration dates are rendered as horizontal lines, such that the tabular view and the annotated stock price chart are concurrently accessible to the user.

5: The method of claim 1, further comprising:
delivering the interactive tabular view via one or more delivery mechanisms including but not limited to email attachment, FTP transfer, web platform download, in-browser application, desktop client, mobile application, or other electronic communication methods.

6: A system for processing and analyzing options trading data, comprising:
a modular architecture with components including:
a data input module configured to receive options trading data comprising parameters including strike price, expiration date, and trade volume;
a data enrichment module configured to enhance the received data with reference data and derived metrics, including underlying stock attributes and aggregated trade volumes;
a storage module configured to store the enriched data in a multidimensional structure;
a data presentation module configured to generate an interactive tabular view of the enriched data; and
a user interface module configured to enable a user to perform interactive data exploration operations, including but not limited to sorting, filtering, grouping, and drilling down into specific trades,
wherein the system facilitates the identification of noteworthy options activity, including multi-leg spreads and roll transactions.

7: The system of claim 6, further comprising:
displaying dual open interest columns in the interactive tabular view, where one column represents open interest as of the time of the trade and another column represents subsequent-day open interest.

8: The system of claim 6, further comprising:
displaying trade directional interpretations at multiple levels of granularity, including individual trade interpretations and aggregated trade interpretations, within the interactive tabular view.

9: The system of claim 6, further comprising:
automatically overlaying options trading activity on a stock price chart, displayed alongside the interactive tabular view in a vertical or horizontal layout, wherein selected strike prices and/or expiration dates are rendered as horizontal lines, such that the tabular view and the annotated stock price chart are concurrently accessible to the user.

10: The system of claim 6, further comprising:
delivering the interactive tabular view and associated analysis via one or more delivery mechanisms including but not limited to email attachment, FTP transfer, web platform download, in-browser application, desktop client, mobile application, or other electronic communication methods.

11: A system for presenting dual open interest data columns for options contracts, comprising:
a data input module configured to receive options trading data, including open interest values for a plurality of contracts;
a processing module configured to calculate dual open interest columns, wherein:
a first column represents open interest at the time of the trade; and
a second column represents subsequent-day open interest; and
a data presentation module configured to generate an interactive tabular view displaying the dual open interest columns,
wherein the system enables comparative analysis of trade directionality and market activity.
